(19) United States
(12) Patent Application Publication
(10) Pub. No.: US 2024/0342931 A1
(43) Pub. Date: Oct. 17, 2024

(54) AIR PURGE MECHANISM, ROBOT, AND AIR PURGE METHOD

(71) Applicant: FANUC CORPORATION, Yamanashi (JP)

(72) Inventor: Kouhei HANATANI, Yamanashi (JP)

(73) Assignee: FANUC CORPORATION, Yamanashi (JP)

(21) Appl. No.: 18/291,433

(22) PCT Filed: Sep. 22, 2021
(86) PCT No.: PCT/JP2021/034709

§ 371 Date: Jan. 23, 2024

(51) Int. Cl. B25J 19/00

(52) U.S. Cl. CPC B25J 19/0079; B25J 19/0029

(57) ABSTRACT

An air purge mechanism includes: a plurality of containers accommodating electrical connection parts; and a cable connecting the containers. One of the containers is provided with an air supply port through which compressed air is supplied to the container. The cable includes a wire bundle formed by bundling a group of wires connected to the electrical connection parts, and a sheath covering an exterior surface of the wire bundle. The interior spaces of two of the containers are connected to each other via gaps between the wires inside the sheath.

### TECHNICAL FIELD

The present disclosure relates to an air purge mechanism, a robot, and an air purge method.

### BACKGROUND

A conventional structure for preventing outside air from coming into contact with an electric motor of a robot is known (for example, see Japanese Unexamined Patent Application, Publication No. Sho 62-63090). The structure in Japanese Unexamined Patent Application, Publication No. Sho 62-63090 is an explosion-proof structure for preventing an external flammable gas from coming into contact with the electric motor. In this structure, the electric motor is accommodated in a sealed container, a base of the robot is provided with a header for supplying a non-flammable protective gas, the sealed container and the header are connected to each other by a tube, and a wiring cable is accommodated in the tube.

### SUMMARY

According to an aspect of the present disclosure, there is provided an air purge mechanism including: a plurality of containers accommodating electrical connection parts; and a cable connecting the containers. One of the containers is provided with an air supply port through which compressed air is supplied thereto. The cable includes a wire bundle formed by bundling a group of wires connected to the electrical connection parts, and a sheath covering an exterior surface of the wire bundle. Interior spaces of two of the containers are connected to each other via gaps between the wires inside the sheath.

### BRIEF DESCRIPTION OF DRAWINGS

FIG. 1 is a side view illustrating a robot according to a first embodiment of the present disclosure.

FIG. 2 is a rear view illustrating the robot in FIG. 1.

FIG. 3 is a partial sectional view taken along line X-X in FIG. 2.

FIG. 4 is a partial sectional view taken along line Y-Y in FIG. 2.

FIG. 5 is a sectional view schematically illustrating the internal structure of a wire distribution box provided in the robot in FIG. 1.

FIG. 6 is a partial sectional view schematically illustrating wiring to an internal space of a second arm in the robot in FIG. 1.

FIG. 7 is a lateral sectional view illustrating an example of a cable constituting an air purge mechanism provided in the robot in FIG. 1.

FIG. 8 is a front view illustrating a spacer and a tube joint retrofittable to the robot in FIG. 1.

FIG. 9 is a lateral sectional view illustrating a modification of the cable in FIG. 7.

FIG. 10 is a view illustrating a modification of the air purge mechanism provided in the robot in FIG. 1.

FIG. 11 is a view illustrating another modification of the air purge mechanism provided in the robot in FIG. 1.

### DETAILED DESCRIPTION OF EMBODIMENTS

An air purge mechanism 30, a robot 1, and an air purge method according to a first embodiment of the present disclosure will be described below with reference to the drawings.

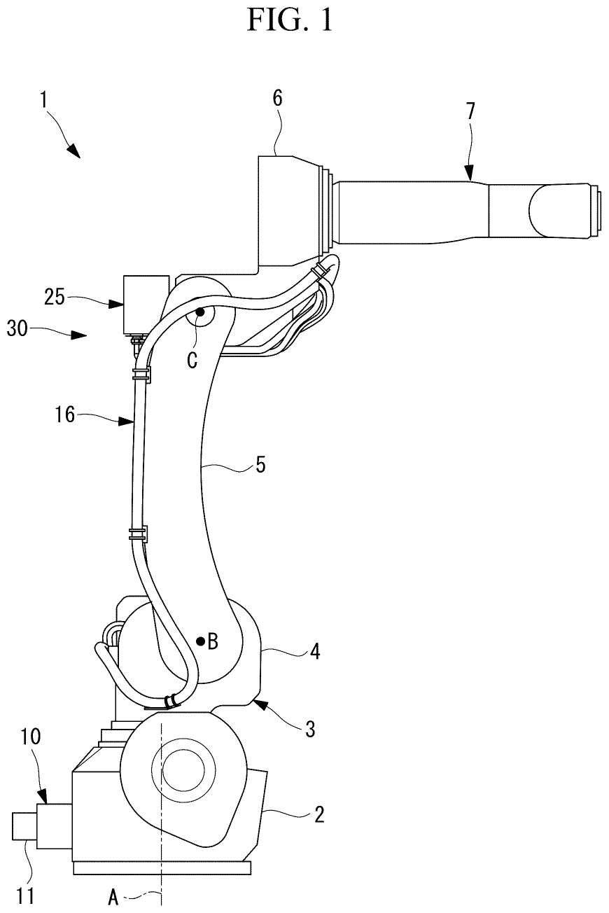

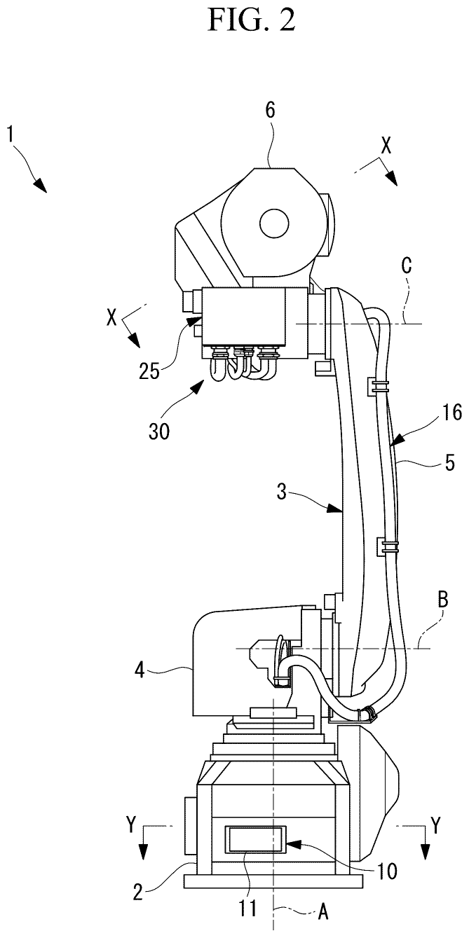

The robot 1 according to this embodiment is, for example, a vertical six-axis articulated type robot, and, as illustrated in FIGS. 1 and 2, includes a base 2 fixed to an installation surface, such as a floor, and a movable part 3, which is moved relative to the base 2.

The movable part 3 includes a revolving drum 4 supported so as to be rotatable about a first axis A relative to the base 2. The movable part 3 also includes a first arm 5 supported so as to be rotatable about a second axis B, which is disposed in a plane orthogonal to the first axis A, relative to the revolving drum 4, and a second arm 6 supported so as to be rotatable about a third axis C, which is parallel to the second axis B. The movable part 3 also includes a three-axis wrist unit 7 at the distal end of the second arm 6.

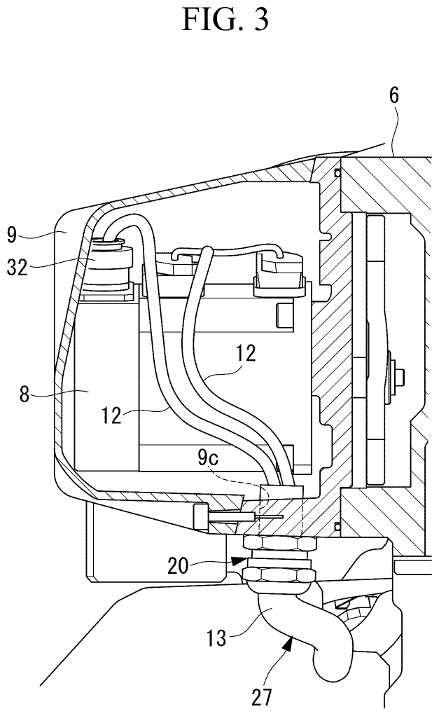

The robot 1 includes a first motor for rotating the revolving drum 4 relative to the base 2, a second motor for rotating the first arm 5 relative to the revolving drum 4, a third motor for rotating the second arm 6 relative to the first arm 5, and a fourth motor 8, a fifth motor, and a sixth motor for operating the wrist unit 7. FIG. 3 illustrates only the fourth motor 8.

The first motor is disposed in the base 2. The second motor is disposed in the revolving drum 4. The inside of the base 2 and the inside of the revolving drum 4 communicate with each other and are sealed from the outside.

The third motor is accommodated in the second arm 6.

As illustrated in FIG. 3, the fourth motor 8 is fixed to the second arm 6 and is sealed from the outside by an enclosed container formed of the second arm 6 and a cover 9 attached to the second arm 6.

The wrist unit 7 is rotatable relative to the second arm 6 in a state in which the joint between the wrist unit 7 and the second arm 6 is sealed with a rotary seal member (not illustrated). With this structure, the second arm 6 and the wrist unit 7 constitute an enclosed container sealed from the outside. The fifth motor and the sixth motor are accommodated in the wrist unit 7.

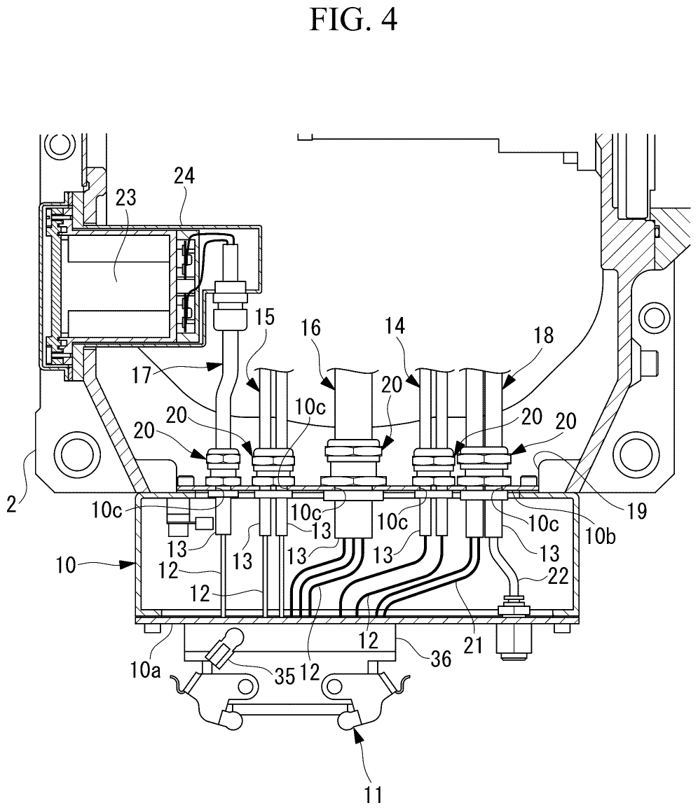

As illustrated in FIG. 4, a power distribution box (container) 10 is fixed to the base 2. The power distribution box 10 constitutes a rectangular-parallelepiped box-shaped enclosed container sealed from the outside. A connector 11, to which a cable (not illustrated) extending from a controller (not illustrated) can be connected, is disposed on an exterior surface of the power distribution box 10.

The connector 11 is fixed at a position closing a through-hole (not illustrated) penetrating through a side wall 10a of the power distribution box 10 in the thickness direction. In the power distribution box 10, wires 12 are connected, by soldering, to a plurality of terminals (electrical connection parts) (not illustrated) of the connector 11, the terminals being disposed inside the power distribution box 10.

As illustrated in FIG. 4, the wires 12 headed to the same destinations are bundled into a plurality of wire bundles, the wire bundles are covered with sheaths 13 on the exterior surfaces thereof to form a plurality of cables 14, 15, 16, 17, and 18, and are guided into the base 2 through another side wall 10b of the power distribution box 10 disposed at a position closing an opening 19 in the base 2. The sheaths 13 are made of an electrically insulating, water-resistant material, such as PVC (polyvinyl chloride).

The cables 14, 15, 16, 17, and 18 are fixed, with known cable glands 20 fixed to a plurality of through-holes 10c penetrating through the side wall 10b of the power distribution box 10 in the thickness direction, to the side wall 10b of the power distribution box 10 in a state of passing through the through-holes 10c. The cable glands 20 can seal gaps around the exterior surfaces of the sheaths 13 when nuts are tightened, and can fix, by means of friction with respect to the exterior surfaces of the sheaths 13, the cables 14, 15, 16, 17, and 18 such that the cables do not move in the longitudinal direction and the circumferential direction.

The cables 14, 15, 16, 17, and 18, which pass through the side wall 10b of the power distribution box 10 by the cable grounds 20, include the first cable 14 connected to the first motor, the second cable 15 connected to the second motor, and the third cable 16 connected to the third to sixth motors. The cables 14, 15, 16, 17, and 18, which pass through the side wall 10b of the power distribution box 10 by the cable glands 20, include the fourth cable 17 connected to a battery 23 (described below) and the fifth cable 18 including a user signal wire 21 and an air tube 22.

As illustrated in FIG. 4, the robot 1 includes the battery 23 for data storage. The battery 23 is attachable to and detachable from the side surface of the base 2 and is accommodated in a sealed state in a battery case (case) 24 disposed inside the base 2.

As illustrated in FIGS. 1 and 2, the robot 1 includes the wire distribution box (container) 25 at the rear end of the second arm 6.

The robot 1 according to this embodiment includes an air purge mechanism 30.

The air purge mechanism 30 includes a plurality of containers, such as the power distribution box 10, the battery container 24, the wire distribution box 25, the cover 9, and the second arm 6, and the cables 14, 15, 16, 17, and 18 connecting these containers.

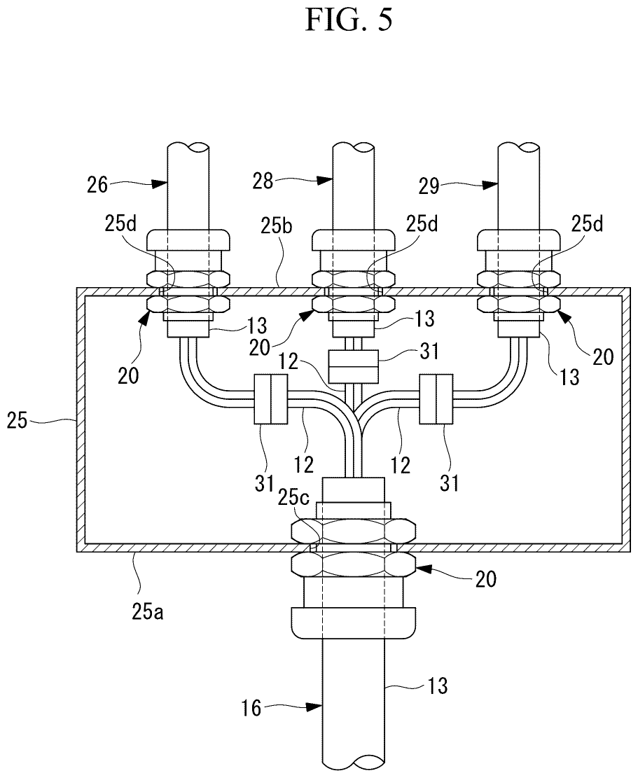

The power distribution box 10 accommodates soldered portions, serving as electrical connection parts, between the terminals of the connector 11 and the wires 12. The battery container 24 accommodates screw connection portions, serving as electrical connection parts, between terminals of the battery 23 and the wires 12. As illustrated in FIG. 5, the third cable 16, in which wire bundles for the third to sixth motors are collectively covered with the sheath 13, passes through a through-hole 25c in a wall 25a of the wire distribution box 25 and is fixed in a sealed state with the cable gland 20.

In the wire distribution box 25, the wires 12 for the third to sixth motors, exposed from one end of the sheath 13 of the third cable 16, are bundled into wire bundles for the respective motors and branched. FIG. 5 illustrates three of such wire bundles.

Furthermore, branch cables 26, 27, 28, and 29 for the third to sixth motors pass through through-holes 25d in another wall 25b of the wire distribution box 25 and are fixed in a sealed state with the cable glands 20.

The branch cables 26, 27, 28, and 29 are formed by covering the exterior surfaces of the wire bundles for the third to sixth motors with the sheaths 13. Each of the branch cables 26, 27, 28, and 29 is connected to a corresponding one of the plurality of wire bundles in the third cable 16 by a connector 31.

Specifically, the wire distribution box 25 accommodates the connectors 31, serving as electrical connection parts, for detachably connecting the wires 12 of the third cable 16 and the wires 12 of the branch cables 26, 27, 28, and 29.

As illustrated in FIG. 3, the branch cable 27 for the fourth motor 8, among the branch cables 26, 27, 28, and 29, passes through a through-hole 9c provided in the cover 9 and is fixed to the cover 9 in a state in which the gap between the sheath 13 and the through-hole 9c is sealed with the cable gland 20.

In the interior space of the cover 9, the wire 12 for the fourth motor 8, exposed from the end face of the sheath 13 of the branch cable 27 fixed to the cover 9, is connected, by a connector 32, to the fourth motor 8 accommodated in the cover 9 in a sealed state.

In other words, the cover 9 accommodates the connector 32, serving as an electrical connection part, connected to the fourth motor 8.

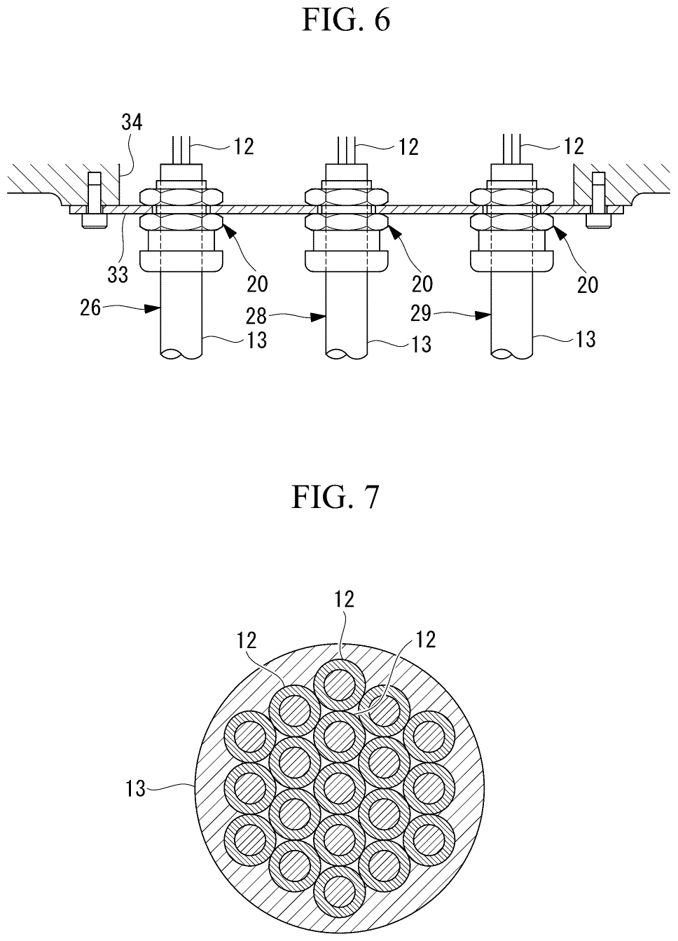

Similarly, as illustrated in FIG. 6, the other branch cables 26, 28, and 29 fixed to the wire distribution box 25 pass through a plate 33, which closes an opening 34 provided in the second arm 6 in a sealable manner, and are fixed to the plate 33 with the cable glands 20. The plate 33 is detachably fixed with screws to the exterior surface of the second arm 6 with a gasket (not illustrated) interposed therebetween.

In the interior space of the second arm 6, at the distal end of the branch cable 26 fixed to the plate 33, the wires 12 for the third motor exposed from the end face of the sheath 13 are connected to the third motor accommodated in a sealed state in the interior space of the second arm 6.

In the interior space of the wrist unit 7, at the distal ends of the other branch cables 28 and 29 fixed to the plate 33, the wires 12 for the fifth motor and the sixth motor are connected to the fifth motor and the sixth motor accommodated in a sealed state in the interior space of the wrist unit 7.

In other words, the interior spaces of the second arm 6 and the wrist unit 7 also accommodate the connectors, serving as electrical connection parts, connected to the third, fifth, and sixth motors.

As illustrated as an example in FIG. 7, each of the cables 14, 15, 16, 17, and 18 includes a wire bundle formed by bundling a group of wires 12 and a sheath 13 covering the wire bundle so as to be in close contact with the exterior surface of the wire bundle. Each of the wires 12 has, for example, a circular cross-sectional shape, and there are gaps between the wires 12 in the wire bundle. The sheath 13 is formed so as to tighten the wire bundle from outside in the radial direction. Hence, the covers of the wires 12 are compressed in the radial direction, but do not enter the gaps between the wires 12. With this structure, inside the sheaths 13 of the cables 14, 15, 16, 17, and 18, gaps extending over the overall length of the cables 14, 15, 16, 17, and 18 in the longitudinal direction are formed between a group of wires 12 constituting the wire bundles.

The interior space of the power distribution box 10 is connected to the interior space of the wire distribution box 25 by the gaps formed in the third cable 16 and the interior space of the battery container 24 by the gaps formed in the fourth cable 17. Furthermore, the interior space of the wire distribution box 25 is connected to the interior space of the cover 9, the interior space of the second arm 6, and the interior space of the wrist unit 7 by the gaps formed in the branch cables 26, 27, 28, and 29.

The power distribution box 10 is provided with a tube joint (air supply port) 35 to which a tube extending from an external air pressure supply source is detachably connected. By connecting the tube to the tube joint 35, it is possible to supply compressed air, supplied from the air pressure supply source via the tube, to the interior space of the power distribution box 10.

In this embodiment, as illustrated in FIG. 8, a spacer 36 having a rectangular frame shape substantially the same as the outline of the connector 11 is disposed between the connector 11 of the power distribution box 10 and the side wall 10a to which the connector 11 is fixed. The tube joint 35 is fastened to the spacer 36, at a screw hole 37 penetrating through the side wall 10a. The spacer 36 and the side wall 10a, and the spacer 36 and the connector 11 are sealed with gaskets (not illustrated). The inner opening of the spacer 36 is large enough to allow the connector 11 with the wires 12 connected to the terminals thereof to pass therethrough in a proper direction.

The thus-configured air purge mechanism 30 and the air purge method using the robot 1 according to this embodiment will be described below.

The air purge method according to this embodiment includes: connecting the interior spaces of the power distribution box 10, the wire distribution box 25, the battery container 24, the cover 9, the second arm 6, and the wrist unit 7 by the third cable 16, the fourth cable 17, and the branch cables 26, 27, 28, and 29; and supplying dry air to the power distribution box 10.

More specifically, a tube led from a dry air supply device disposed on the outside is connected to the tube joint 35 provided on the spacer 36 of the power distribution box 10, and dry air is supplied via the tube. The dry air supply device is, for example, a device that removes dust and moisture in the air supplied from an air supply source provided in a factory.

When the dry air supplied via the tube is supplied to the power distribution box 10 via the tube joint 35, the pressure in the power distribution box 10 increases. The interior space of the power distribution box 10 is connected to the interior spaces of the battery container 24 and the wire distribution box 25 via the gaps inside the sheaths 13 of the third cable 16 and the fourth cable 17. Thus, the dry air supplied to the power distribution box 10 is supplied to the interior spaces of the battery container 24 and the wire distribution box 25 via the gaps.

The interior space of the wire distribution box 25 is connected to the interior space of the cover 9, the interior space of the second arm 6, and the interior space of the wrist unit 7 via the gaps inside the sheaths 13 of the branch cables 26, 27, 28, and 29. Thus, the dry air supplied to the wire distribution box 25 is supplied to the interior spaces of the cover 9, the second arm 6, and the wrist unit 7 via the gaps.

As a result, the interior spaces of the battery container 24, the wire distribution box 25, the cover 9, the second arm 6, and the wrist unit 7 are filled with the compressed dry air, and thus, it is possible to prevent water vapor or the like from entering these spaces from the outside. By maintaining the humidity of the interior spaces of the battery container 24, the wire distribution box 25, the cover 9, the second arm 6, and the wrist unit 7 low, it is possible to prevent the occurrence of dew condensation inside these spaces and thus to prevent the occurrence of a short circuit, rust, and the like at the electrical connection parts.

In this case, according to this embodiment, because the gaps formed between the wires 12 in the sheaths 13 are used as passages for the dry air, there is no need to provide separate tubes for forming flow paths around the cables 14, 15, 16, 17, and 18. Therefore, it is possible to prevent an increase in wiring space due to the use of tubes having a larger outer diameter than the cables 14, 15, 16, 17, and 18.

Furthermore, because the task of inserting the cables 14, 15, 16, 17, and 18 through the tubes is unnecessary, the manufacturing cost is low. Furthermore, there is an advantage in that it is possible to prevent a decrease in flexibility due to the provision of tubes on the outer side of the cables 14, 15, 16, 17, and 18, and in particular, it is possible to maintain the deformability of the movable cable, such as the third cable 16, to maintain the durability of the cables 14, 15, 16, 17, and 18.

Furthermore, according to the robot 1 of this embodiment, when there is no need to fill the interior spaces of the battery container 24, the wire distribution box 25, the cover 9, the second arm 6, and the wrist unit 7 with dry air, the dry air does not need to be supplied to the power distribution box 10. In that case, the tube joint 35, to which the tube from the dry air supply device is connected, is unnecessary, so, the tube joint 35 may be removed together with the spacer 36.

Assuming that the robot 1 used in an environment requiring no air purge is a standard robot, a robot used in an environment requiring air purging can be formed by a minimum modification, i.e., retrofitting the spacer 36 having the tube joint 35 attached thereto. Thus, there is an advantage in that many parts can be shared regardless of the necessity for air purging, thus reducing the time and cost required for modification.

Although the vertical six-axis articulated type robot has been described as an example of the robot 1 in this embodiment, the robot is not limited thereto, and the present disclosure can be applied to any other type of robot. Furthermore, although the power distribution box 10, the battery container 24, the wire distribution box 25, the cover 9, the second arm 6, and the wrist unit 7 have been described as examples of the containers to be purged with dry air, the containers are not limited thereto. For example, the present disclosure may be applied to a container, a cover, or the like for accommodating an electrical component, such as a solenoid valve or a tool-driving motor, attached to the arm or the wrist by a user.

Furthermore, for example, a pressure sensor for detecting the pressure in the wire distribution box 25 may be attached to the wire distribution box 25, or a tube joint (pressure detection port) to which a pressure sensor can be attached as necessary may be provided on the wire distribution box 25. By doing so, when an abnormality, such as a hole being formed in any of the sheaths 13 of the cables 14, 15, 16, 17, and 18, occurs, the abnormality can be detected as a pressure drop, and it is possible to check if air purging is reliably performed.

In that case, the pressure sensor may include a communication unit, and, when the pressure is lower than a predetermined threshold, the controller or another notification unit may notify a user of the fact. The pressure sensor or the pressure detection port may be provided in any of the containers 24 and 25, other than the power distribution box 10.

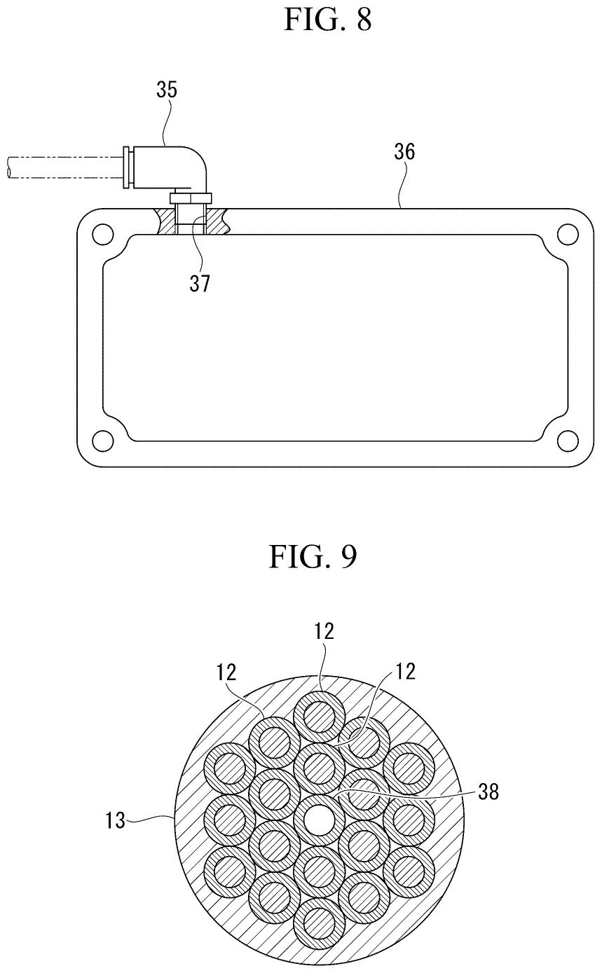

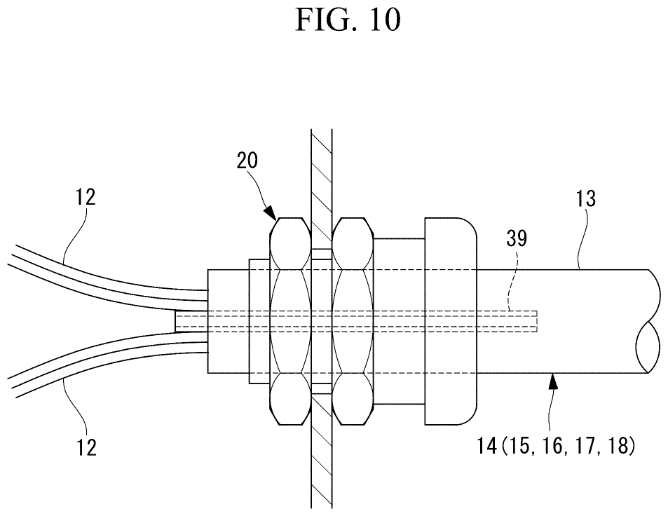

In this embodiment, the cables 14, 15, 16, 17, and 18 are attached to the containers with the cable glands 20. In this case, because the sheaths 13 of the cables 14, 15, 16, 17, and 18 are tightened from the exterior surfaces thereof with the cable glands 20, the gaps between the wires 12 are reduced, and the air flow cross-sectional area may be reduced. To counter this, the cables 14, 15, 16, 17, and 18 may include one or more tubes 38 in the wire bundles, as illustrated in FIG. 9, or a reinforced tube 39 made of a hard material to ensure a gap may be inserted and arranged only in the portion tightened by the cable gland 20, as illustrated in FIG. 10. Similarly, the branch cables 26, 27, 28, and 29 may include one or more tubes 38 in the wire bundles, or the reinforced tube 39 may be inserted and arranged only in the portion tightened by the cable gland 20.

In this embodiment, compressed air is supplied to the power distribution box 10. Instead of this, compressed inert gas, such as nitrogen gas, may be supplied.

Furthermore, although the dry air supply device is disposed outside the robot 1, the dry air supply device may be mounted on the power distribution box 10. By doing so, the compressed air to be used for air purging can be dehumidified and dried only by allowing the compressed air supplied from the air pressure supply source in the factory to pass through the dry air supply device.

Furthermore, instead of the spacer 36, a screw hole that can be opened and closed by a plug or the like may be provided in the power distribution box 10, so that the tube joint 35 can be mounted to the screw hole from which the plug has been removed when the supply of dry air is required.

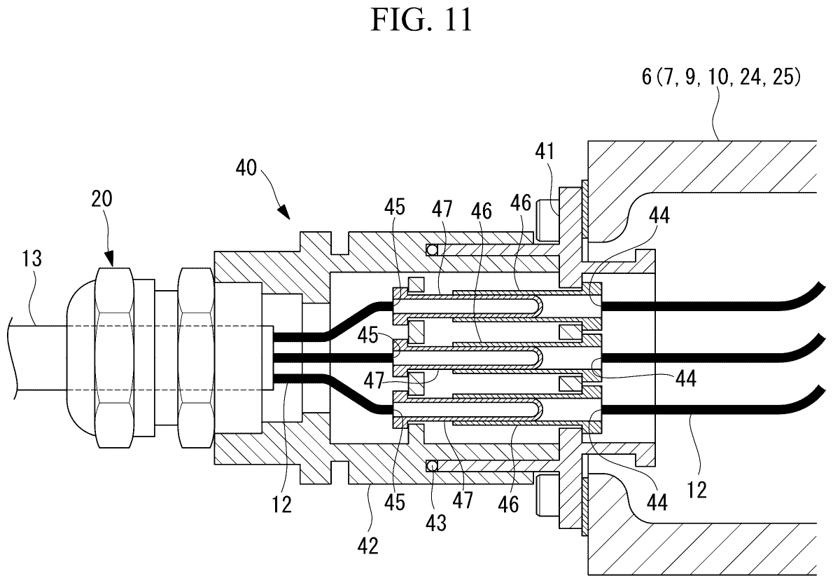

Furthermore, although the cables 14, 15, 16, 17, and 18 are attached to the containers 6, 7, 9, 10, 24, and 25 with the cable glands 20, the cables 14, 15, 16, 17, and 18 may be connected to the containers 6, 7, 9, 10, 24, and 25 with connectors 40 that protect the inside against water on the outside only when fitted and can communicate between the spaces in the sheaths 13 of the cables 14, 15, 16, 17, and 18, as illustrated in FIG. 11.

Specifically, the connector 40 includes: a first housing 41 to be attached to the container 6, 7, 9, 10, 24, or 25; a second housing 42 to be attached to the cable ground 20; an O-ring 43 disposed between the first housing 41 and the second housing 42; and contacts 46 and 47 having, at one end thereof, connection portions 44 and 45, respectively, to which the wires 12 are connected. When the pin-shaped contacts 47 are inserted into the cylindrical contacts 46, the contacts 46 and the contacts 47 are fitted together.

With this structure, when the first housing 41 and the second housing 42 are fitted together, the O-ring 43 disposed between the first housing 41 and the second housing 42 is compressed, and the first housing 41 and the second housing 42 are brought into close contact with each other. As a result, the inside of the connector 40 is sealed and is protected against water on the outside. Furthermore, because the contacts 46 and 47 and the first housing 41 and the second housing 42 are not sealed, the connector 40 can supply the compressed air supplied via the spaces in the sheaths 13 to the containers 6, 7, 9, 10, 24, and 25 through the gaps in the connector 40. Herein, there are gaps between the plurality of components in the connector 40, or there are holes in the components due to manufacturing reasons or the like.

1. An air purge mechanism, comprising:
a plurality of containers accommodating electrical connection parts; and
a cable connecting the containers,
wherein one of the containers is provided with an air supply port through which compressed air is supplied thereto,
the cable includes a wire bundle formed by bundling a group of wires connected to the electrical connection parts, and a sheath covering an exterior surface of the wire bundle, and
interior spaces of two of the containers are connected to each other via gaps between the wires inside the sheath.

2. The air purge mechanism according to claim 1, wherein the containers are enclosed containers.

3. The air purge mechanism according to claim 2, wherein any of the containers not provided with the air supply port is provided with a pressure detection port or a pressure sensor for detecting a pressure inside.

4. The air purge mechanism according to claim 1, further comprising a dry air supply device connected to the air supply port.

5. A robot, comprising:
a base fixed to an installation surface;
a movable part provided so as to be movable relative to the base; and
the air purge mechanism according to claim 1, wherein
the one of the containers provided with the air supply port is fixed to the base, and
another of the containers not provided with the air supply port is fixed to the movable part.

6. An air purge method, comprising:
connecting a plurality of containers accommodating electrical connection parts with a cable including a wire bundle formed by bundling a group of wires connected to the electrical connection parts, and a sheath covering an exterior surface of the wire bundle;
supplying compressed air to one of the containers; and
supplying the compressed air supplied to the one of the containers to another of the containers via gaps between the wires inside the sheath of the cable.
